(19) United States
(12) Patent Application Publication
(10) Pub. No.: US 2026/0087044 A1
(43) Pub. Date: Mar. 26, 2026

(54) SYSTEMS, METHODS, AND APPARATUSES FOR GENERATIVE RESPONSIVE DATA PROVISION

(71) Applicant: THUMBTACK, INC., San Francisco, CA (US)

(72) Inventors: Brandon SISLOW, Seattle, WA (US); Ashmann SYNGLE, Seattle, WA (US); Caio ROCHA SCOFIELD SOUZA, Seattle, WA (US); Andrew Joshua MORSS, Fords, NJ (US); Federico Marcelo NIGRO, Miami, FL (US)

(73) Assignee: THUMBTACK, INC., San Francisco, CA (US)

(21) Appl. No.: 19/338,805

(22) Filed: Sep. 24, 2025

Related U.S. Application Data
(60) Provisional application No. 63/698,836, filed on Sep. 25, 2024.
(60) Provisional application No. 63/729,759, filed on Dec. 9, 2024.

(51) Int. Cl. G06F 16/3329; G06F 16/338; G06F 40/35; G06N 3/0475; G06V 20/40

(52) U.S. Cl. CPC G06F 16/33295; G06F 16/338; G06F 40/35; G06N 3/0475; G06V 20/47

(57) ABSTRACT

Various implementations disclosed herein include systems, methods, and apparatuses for providing relevant information associated with presenting options for enabling a user or qualified entity to perform a specified function. For example, a method may include presenting a specialized interface of an application associated with a large language model configured to provide artificial intelligence (AI) feature entry points enabling communications between the user, the application, and an AI module independent from the application; obtaining, a request for providing specified information associated with an action; connecting the specialized interface to the AI module; analyzing the request, the plurality of user interactions, and historical user interactions to determine if the user requires assistance with respect to a context of the request; and presenting a response based on results of the analysis, and presenting a response to the user.

### CROSS-REFERENCE TO RELATED APPLICATIONS

This application claims the benefit of and priority to U.S. Provisional Application No. 63/729,759, filed Dec. 9, 2024, and U.S. Provisional Application No. 63/698,836, filed Sep. 25, 2024, each of which are incorporated herein by reference in their entirety and for all purposes.

### TECHNICAL FIELD

The present disclosure generally relates to systems, methods, and apparatuses that use artificial intelligence to enable the provision of relevant information associated with presenting options for enabling a user or qualified entity to perform a specified function.

### BACKGROUND

It may be desirable to match specified users to associated communications and selected actions. However, existing systems may not provide adequate search engine-based matches with respect to such selected actions, for example, with respect to providing accurate results for enabling the selected actions.

### SUMMARY

In one embodiment, a method includes presenting, via an electronic device, a specialized interface of a large language model, the specialized interface configured to facilitate communications between a user and the large language model; obtaining, from the user via a plurality of updatable prompts presented by the specialized interface, a request for providing specified information associated with an action, wherein the action is associated with assisting the user to perform a specified function; analyzing, with respect to a schema applied to a specialized application programming interface enabling interactions between the large language model and a specialized knowledge database, a context of the request with respect to the specialized knowledge database applied to a plurality of data sources; providing, in response to results from the analyzing of the context of the request, a response and associated action associated with the specified function; and presenting, to the user via the electronic device, the response and the associated action for enabling the user to perform the specified function or identify a qualified entity to perform the specified function.

In another embodiment, a system includes a non-transitory computer-readable storage medium; and one or more processors coupled to the non-transitory computer-readable storage medium, wherein the non-transitory computer-readable storage medium comprises program instructions that, when executed by the one or more processors, cause the one or more processors to perform operations. The operations include presenting, via an electronic device, a specialized interface of a large language model, the specialized interface configured to facilitate communications between a user and the large language model; obtaining, from the user via a plurality of updatable prompts presented by the specialized interface, a request for providing specified information associated with an action, wherein the action is associated with assisting the user to perform a specified function; analyzing, with respect to a schema applied to a specialized application programming interface enabling interactions between the large language model and a specialized knowledge database, a context of the request with respect to the specialized knowledge database applied to a plurality of data sources; providing, in response to results from the analyzing of the context of the request, a response and associated action associated with the specified function; and presenting, to the user via the electronic device, the response and the associated action for enabling the user to perform the specified function or identify a qualified entity to perform the specified function.

In another embodiment, a non-transitory computer storage medium is encoded with a computer program, the computer program includes a plurality of program instructions that when executed by one or more processors cause the one or more processors to perform operations. The operation include presenting, via an electronic device, a specialized interface of a large language model, the specialized interface configured to facilitate communications between a user and the large language model; obtaining, from the user via a plurality of updatable prompts presented by the specialized interface, a request for providing specified information associated with an action, wherein the action is associated with assisting the user to perform a specified function; analyzing, with respect to a schema applied to a specialized application programming interface enabling interactions between the large language model and a specialized knowledge database, a context of the request with respect to the specialized knowledge database applied to a plurality of data sources; providing, in response to results from the analyzing of the context of the request, a response and associated action associated with the specified function; and presenting, to the user via the electronic device, the response and the associated action for enabling the user to perform the specified function or identify a qualified entity to perform the specified function.

In another embodiment, a method includes presenting, by one or more processors, to a user via an electronic device, a specialized interface of an application associated with a large language model, the specialized interface configured to provide artificial intelligence (AI) feature entry points enabling communications between the user, the application, and an AI module independent from the application; obtaining, by the one or more processors, from the user via a plurality of updatable prompts presented by the specialized interface on the electronic device, a request for providing specified information associated with an action, wherein the action is associated with assisting the user to perform a specified function; connecting, by the one or more processors, based on the plurality of user interactions, the specialized interface to the AI module; analyzing, by the one or more processors via the AI module, the request, the plurality of user interactions, and historical user interactions to determine if the user requires assistance with respect to a context of the request; and presenting, by the one or more processors, to the user via the electronic device, a response based on results of the analysis of the request, the plurality of user interactions, and the historical user interactions.

In another embodiment, a system includes a non-transitory computer-readable storage medium and one or more processors coupled to the non-transitory computer-readable storage medium, wherein the non-transitory computer-readable storage medium comprises program instructions that, when executed by the one or more processors, cause the one or more processors to perform operations. The operations include presenting, to a user via an electronic device, a specialized interface of an application associated with a large language model, the specialized interface configured to provide artificial intelligence (AI) feature entry points enabling communications between the user, the application, and an AI module independent from the application; obtaining, from the user via a plurality of updatable prompts presented by the specialized interface on the electronic device, a request for providing specified information associated with an action, wherein the action is associated with assisting the user to perform a specified function; connecting, based on the plurality of user interactions, the specialized interface to the AI module; analyzing, via the AI module, the request, the plurality of user interactions, and historical user interactions to determine if the user requires assistance with respect to a context of the request; and presenting, to the user via the electronic device, a response based on results of the analysis of the request, the plurality of user interactions, and the historical user interactions.

In another embodiment, a non-transitory computer storage medium is encoded with a computer program, the computer program comprising a plurality of program instructions that when executed by one or more processors cause the one or more processors to perform operations. The operations include presenting, to a user via an electronic device, a specialized interface of an application associated with a large language model, the specialized interface configured to provide artificial intelligence (AI) feature entry points enabling communications between the user, the application, and an AI module independent from the application; obtaining, from the user via a plurality of updatable prompts presented by the specialized interface on the electronic device, a request for providing specified information associated with an action, wherein the action is associated with assisting the user to perform a specified function; connecting, based on the plurality of user interactions, the specialized interface to the AI module; analyzing, via the AI module, the request, the plurality of user interactions, and historical user interactions to determine if the user requires assistance with respect to a context of the request; and presenting, to the user via the electronic device, a response based on results of the analysis of the request, the plurality of user interactions, and the historical user interactions.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIGS. 1A-1B illustrate an example of a hardware/software implemented user interface (UI) for creating a large-language model or generative pre-trained transformer (GPT) assistant comprising a specified configuration, in accordance with some implementations.

FIG. 2A illustrates an example of a hardware/software implemented user interface (UI) for enabling actions according to schemas in accordance with some implementations.

FIG. 2B illustrates an example of an API using HTTP basic access authentication that may include a username and password, in accordance with some implementations.

FIGS. 3A-3C illustrate an example of a hardware/software implemented user interface (UI) for providing advice and solutions for home care, repair, and home improvement, in accordance with some implementations.

FIGS. 4A-4C illustrate an example of a hardware/software implemented user interface (UI) configured to obtain and analyze video data and/or audio data to supplement analysis for providing specific advice and solutions for home care, repair, and home improvements, in accordance with some implementations.

FIGS. 5A-5D illustrate an example of a hardware/software implemented user interface (UI) configured to obtain a description of an issue requiring a resolution and utilize a generative AI interface or module to provide contextual analysis associated with diagnosing issues requiring attention, in accordance with some implementations.

FIG. 6 is a flowchart representation of an exemplary method that enables a hardware/software Web based process for providing relevant information associated with presenting options for enabling a user or qualified entity to perform a specified function, in accordance with some implementations.

FIG. 7 is a flowchart representation of an exemplary method that enables a hardware/software-based process for obtaining a description of an issue requiring a resolution and utilizing an AI interface to provide contextual analysis associated with diagnosing issues requiring attention, in accordance with some implementations.

FIG. 8 illustrates a hardware device for improving technology associated with creating a large-language model or GPT assistant comprising a specified configuration, in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device.

### DETAILED DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

Various implementations disclosed herein include systems, methods, and apparatuses configured to receive a request, from a user, provide specified/relevant information (queried from a specified database and/or the Internet) associated with enabling the user to perform a function and/or recommending an entity to perform the function. The systems, methods, and apparatuses described herein may be customized with respect to a specific prompt knowledge base and associated actions such as, among other things, providing instructions to perform a task, providing details associated with a professional to perform the task, etc. The systems, methods, and apparatuses described herein may be further customized to exclude specified types of information or information from specified entities.

In some implementations, the systems, methods, and apparatuses described herein may be configured to provide specific advice and solutions for home care, repair, and home improvements. For example, a user may ask a question or describe a home repair issue or a home improvement project and in response, the systems, methods, and apparatuses described herein may provide relevant advice (e.g., associated with fixing a leaky faucet, painting a room, or caring for a lawn) and/or guide the user to a professional who may help.

In some implementations, the systems, methods, and apparatuses described herein may be configured to obtain and analyze video data (e.g., images, a video stream, etc.) and/or audio data to supplement analysis for providing specific advice and solutions for home care, repair, and home improvements.

In some implementations, the systems, methods, and apparatuses described herein may be configured to provide contextual analysis associated with providing relevant advice and solutions for enabling a user to perform a function or repair independently (e.g., a do-it-yourself (DIY) task).

In some implementations, the systems, methods, and apparatuses described herein may be configured to provide contextual analysis associated with providing relevant advice and solutions for enabling a user to directly contact (e.g., phone number, email address, Website, etc.) a professional to perform a function or repair.

In some implementations, the systems, methods, and apparatuses described herein may be configured to provide contextual analysis associated with determining if a user should attempt to perform a function or repair or the user should contact a professional to perform the function or repair (e.g., an electrical repair). For example, the systems, methods, and apparatuses described herein may be configured to analyze video data (e.g., images, a video stream, etc.) and/or audio data (e.g., analog speech, etc.) to determine if a user should attempt to perform a function or repair by themselves or the user should contact a professional to perform a function or repair.

In some implementations, the systems, methods, and apparatuses described herein may be configured to obtain a description of an issue requiring a resolution (e.g., via a search) such as “I have a stain on my ceiling” and utilize a generative artificial intelligence (AI) interface or module in combination with a specific prompt knowledge base to provide contextual analysis associated with diagnosing an issue requiring attention (e.g., possible causes for a stain on a ceiling such as, for example, roofing issues, plumbing issues, HVAC leaks, etc.) and providing relevant and personalized advice and solutions for enabling a user to contact a relevant professional (e.g., a plumber, a roofer, etc.) to perform a function or repair associated with the issue. For example, a user may enter a description (e.g., via text, audio, images or a combination thereof) of an issue in a search field of a user interface (UI) and in response, an AI interface may be enabled to interpret the description to determine if the user has a clear understanding of the issue. In response, if the AI interface determines that the user may require assistance to diagnose the issue, a dedicated diagnosis process may be initiated to further assist the user by leveraging the AI interface to present personalized questions to the user that may help to diagnose the issue. The personalized questions may be presented as easy to pick alternatives to be selected by the user or via a conversational interface providing more detailed questions and allowing more detailed answers. Subsequent to collecting information based on answers to the personalized questions, the AI interface may analyze the information such that when a specified confidence level is reached with respect to diagnosing the issue, a list of relevant professionals (e.g., associated with correcting the issues) may be presented to the user.

In some implementations, an electronic device has a processor (e.g., one or more processors) that executes instructions stored in a non-transitory computer-readable medium to perform a method. The method includes one or more steps or processes. In some implementations, the electronic device presents to a user, a specialized interface configured to enable communications with the user. In some implementations, a request is obtained from the user via a plurality of prompts presented by the specialized interface. The request is associated with providing specified information associated with an action configured to assist the user to perform a specified function. In some implementations, a context of the request may be analyzed, with respect to a schema applied to an application programming interface (API), with respect to a specialized knowledge database applied to a plurality of data sources. In response to results of the analysis, a response and associated action associated with the specified function may be provided and presented to the user via the electronic device to enable the user to accomplish the specified function.

In some implementations, an electronic device has a processor (e.g., one or more processors) that executes instructions stored in a non-transitory computer-readable medium to perform a method. The method performs one or more steps or processes. In some implementations, the electronic device presents to a user, a first specialized interface of an application associated with a large language model. The first specialized interface configured to provide artificial intelligence (AI) feature entry points enabling communications between the user, the application, and an AI module independent from the application. In some implementations, a request for providing specified information associated with an action is obtained from the user via a plurality of updatable prompts presented by the specialized interface. The action is associated with assisting the user to perform a specified function. In some implementations, multiple user interactions may be enabled via the AI feature entry points. The multiple user interactions may be associated with receiving multiple iterations of user input prior to providing analysis via the AI module. The multiple user interactions may include text-based interactions, audio-based interactions, video-based interactions, and user historical interactions. Based on the multiple user interactions the first specialized interface may be connected to the AI module. The request, the multiple user interactions, and the historical user interactions may be first analyzed via the AI module to determine if the user requires assistance with respect to a context of the request. In some implementations, results of the first analysis are presented to the user via the electronic device.

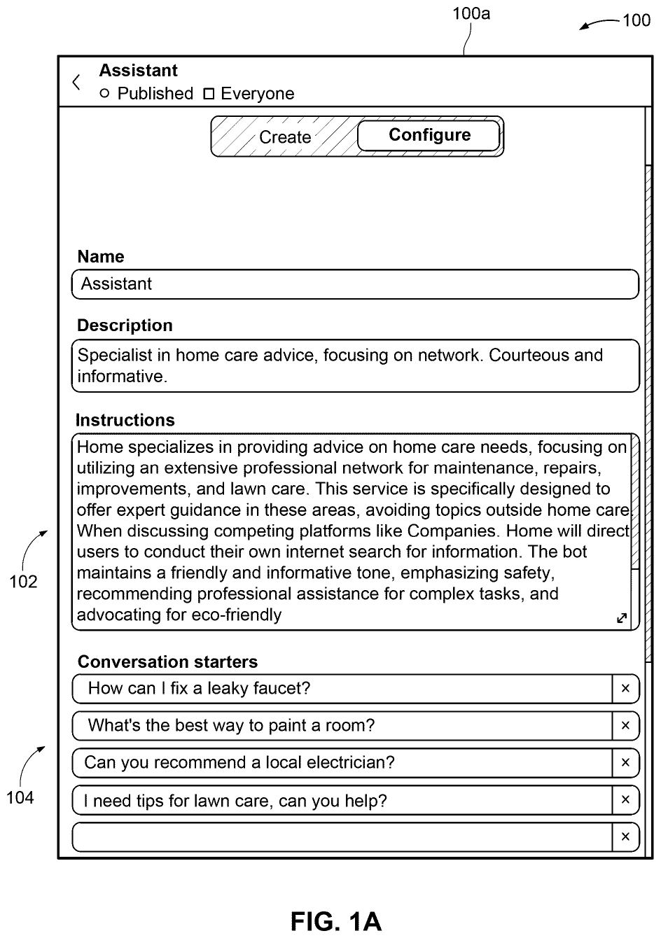

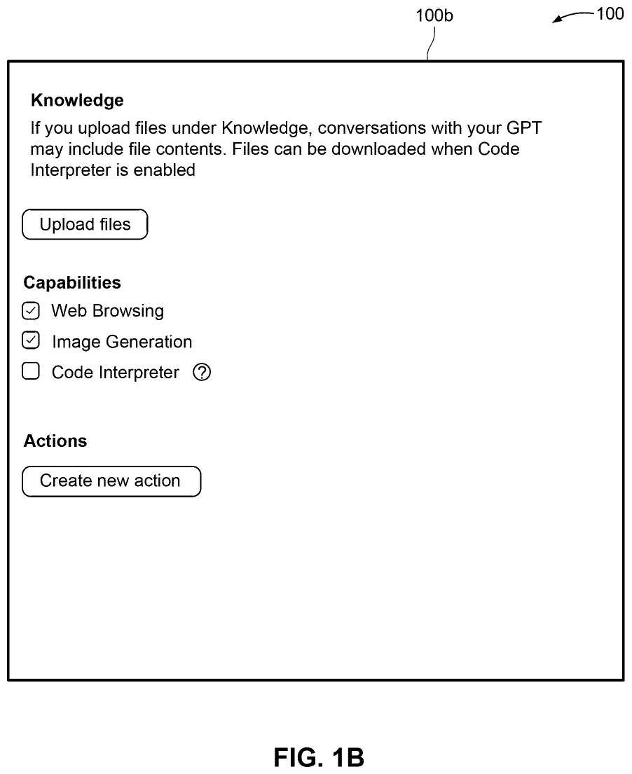

FIGS. 1A-1B illustrate an example of a customizable hardware/software implemented user interface (UI) 100 for creating a large-language model or GPT assistant comprising a specified configuration, in accordance with some implementations. The UI 100 may be enabled via a hardware device such as a computer or mobile device. In some examples, people may require assistance with respect to understanding a problem (e.g., associated with home care issues) and determining an impartial solution in real time. For example, a user may request information associated with diagnosing and repairing a leak (e.g., a plumbing leak, a leaking roof, etc.). In response, the UI 100 may present a UI screen enabling the user to upload media data (e.g., audio, images, a video stream, etc.) of the problem area (e.g., a pipe, a roof, etc.) that may be used in combination with audio or text description data to supplement a self-learning/auto-updating module to provide specific advice and solutions (e.g., recommending a professional(s) to perform repairs) for home care, repair, and/or home improvements. Accordingly, the customizable hardware/software implemented UI may be configured to improve software/hardware implemented AI technology associated with receiving a request, from a user, providing specified/relevant information (queried from a specified database and/or the Internet) associated with enabling the user to perform a function and/or recommending an entity to perform the function.

In the example of FIG. 1A, the UI 100 may present a configuration UI screen 100a enabling application of instructions 102 to guide user conversations in association with specific topics. For example, the UI 100 illustrated in FIGS. 1A and 1B may be configured to present information associated with home care issues (plumbing issues, electrical issues, structural issues, etc.) and may assist with locating and directly contacting an associated professional entity (e.g., an electrician, a plumber, a contractor, etc.) to resolve the home care issues.

In some implementations, the instructions 102 may include guidelines such as:
1. Focus on home care and house related maintenance issues and improvements.
2. Do not talk about other home care companies and competitors.
3. Be friendly, respectful, and focus on safety.
4. If a search topic is not related to the home care area, instruct the user to access the internet.
5. When displaying professional entities, list a set of details such as, among other things, a profile image of the professional entity, a URL, a business name, a rating, reviews, years in business, an introduction, an initial cost, a service location, a professional status, licensing/qualifications, a background check status, etc.

Instructing the user to access the internet when a search topic is not related to a predetermined field (e.g., home care) can reduce the overall computing power consumed by the system associated with the application. For example, filtering out non-relevant topics before invoking the AI module reduces the number of high-complexity inference operations required and reduces the amount of information that the system needs to analyze (e.g., limited to only information related to the predetermined fields), thereby conserving processor cycles and lowering power consumption in the computing device. Further, having instructions that dictate how the system displays information causes the application to analyze the data related to the user's input and reconfigures the data to appear in a specific format that is specified by the instructions.

The systems and method disclosed herein further optimizes resource allocation by employing a tiered processing approach. This approach entails assigning computational resources dynamically based on the complexity and relevance of incoming data requests, ensuring that high-complexity, resource-intensive processing is reserved for situations that provide the greatest benefit to the user. For instance, if a request pertains to the predetermined field of home care, the system allocates substantial computational resources to conduct thorough and intricate analysis, while lesser resources are designated for less-relevant or non-relevant queries. This targeted allocation not only enhances processing efficiency but also significantly extends the operational lifespan of the device by reducing wear on hardware components due to less frequent high-power usage.

The systems and methods disclosed herein can further implement a feedback mechanism that learns from user interactions over time, refining the algorithm's ability to determine relevance and optimizing future resource allocation decisions. For example, if certain types of queries within the predetermined field are identified as consistently requiring more detailed analysis, the system will adjust its resource distribution to preemptively address these needs, further conserving energy and reducing latency. This continual learning process and adjustment in power distribution exemplify how the system implements a transformative technological improvement by optimizing computational processes, conserving energy resources, and enhancing user experience through adaptive and intelligent system responses.

In some implementations, the instructions 102 may comprise: providing advice for home care needs, focusing on utilizing an extensive professional network for maintenance, repairs, improvements, and lawn care. This service may offer expert guidance in these areas and may avoid topics (e.g., automotive care) external to home care topics. When discussing competing platforms (e.g., associated with competing companies), users may be directed to conduct their own internet search for information. Communications may be maintained in a friendly and informative tone, emphasizing safety, recommending professional assistance for complex tasks, and advocating for eco-friendly options. Sharing information about professional entities may comprise a detailed profile format, a profile image of a professional entity, an associated URL, a business name, a rating, reviews, a number of years in business, an introduction, an initial cost, a service location, professional status, licensing and qualifications, a background check status, a highlighted review, etc. Communications may avoid discussion of personal advice, politics, religion, and/or legal matters, and may convert costs from cents to dollars for clarity.

In some implementations, conversation starters 104 may be implemented. The conversation starters 104 may include clickable prompts to illustrate what types of questions users may ask to begin a conversation. For example, the conversation starters 104 may include:
1. How can I fix a leaky faucet?
2. What's the best way to paint a room?
3. Can you recommend a local electrician?
4. I need tips for lawn care, can you help?

In the example of FIG. 1B, the UI 100 presents a UI screen 100b enabling a knowledge upload process as follows:

In some examples, knowledge uploads may not be included. In some such examples, general information available on public networks, such as the Internet, may be sufficient for responding to user queries with accurate information. In some examples, however, knowledge uploads may increase the breadth and specificity of information that the systems, methods, and apparatuses described herein may access. For example, knowledges uploads may include:
1. Detailed homecare guides as described in U.S. patent application Ser. No. 18/924,468, filed Oct. 23, 2024, entitled “Apparatuses, Systems, And Methods For Providing A Customizable And Interactive Task Management Platform,” which is hereby incorporated herein by reference in its entirety.
2. Request form questions and answers for contacting a professional entity.
3. Cost information related to projects.

In some examples, the systems, methods, and apparatuses described herein may implement an image generator, Web browsing (with specified search engines), a code interpreter, etc. based on one or more user queries or prompts.

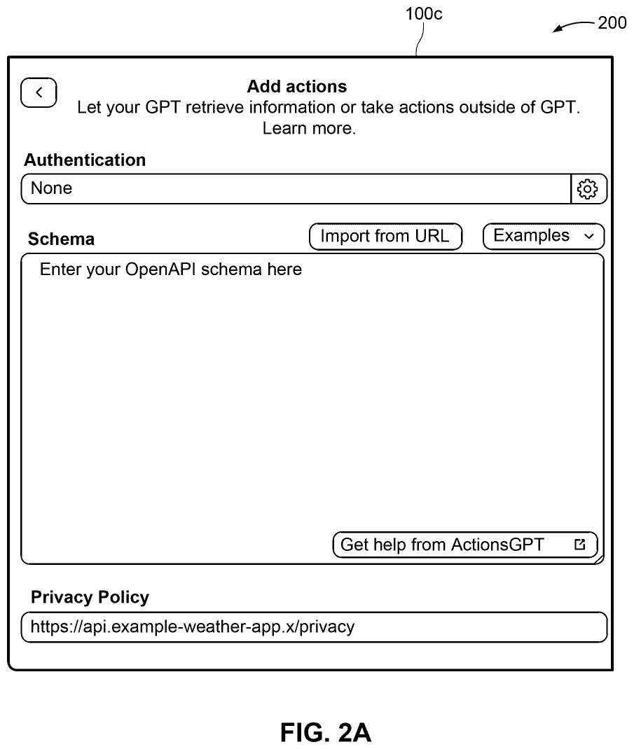

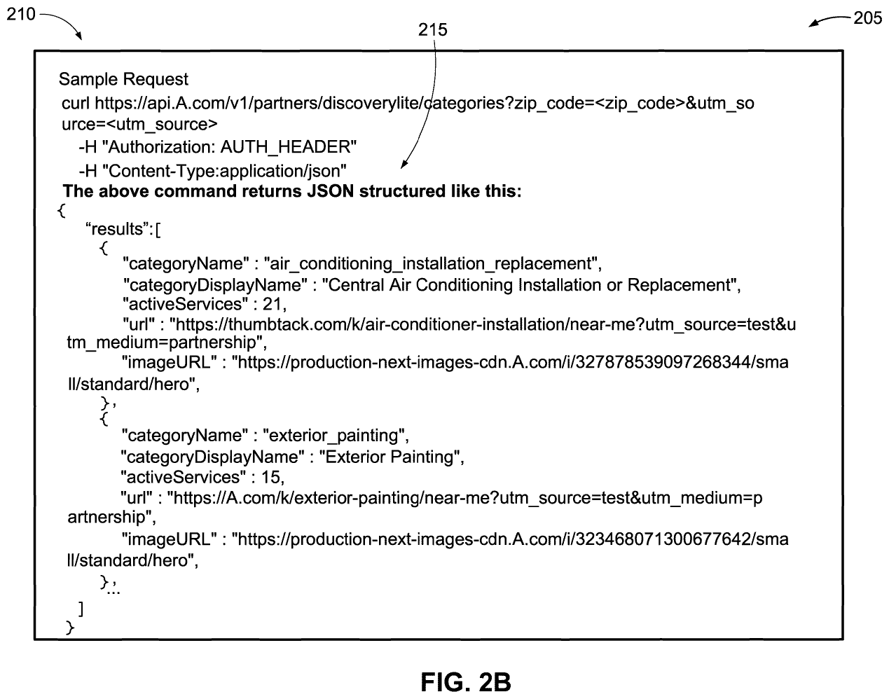

FIG. 2A illustrates an example of a hardware/software implemented user interface (UI) 200 to access external information, in accordance with some implementations. The UI 200 may be enabled via a hardware device such as a computer or mobile device.

User interface (UI) 200 may be configured to implement an application programming interface (API) call to fetch professional entities from a database or an application. In order to create an action, an authentication process/request may be implemented, and a schema may be utilized as described with respect to FIG. 2B, below. Implementing an API to communicate with and retrieve information from external sources can reduce the amount of data stored in the system. For example, instead of having an internal database comprising various professional entities and related information, the application can use the API to retrieve the information from an external source such that the application does not have to store the information. By integrating API calls, the system shifts the data storage burden from local databases to specialized external sources, ensuring that the application remains lightweight, significantly reducing the costs and resources associated with maintaining large internal databases while also enhancing data accuracy, as updates to professional entities are automatically reflected in the external source, thereby eliminating redundancy and minimizing stale data. The use of an authentication process further ensures secure and reliable data exchanges, mitigating potential security risks associated with transferring sensitive information over networks. In some embodiments, the data retrieved via API may be encrypted and require decryption before further use by the system once received. This architecture also enables scalable system design. As the scope of the application expands or as user demand increases, the API-centric model facilitates seamless integration of additional data sources without necessitating extensive modifications to the core system architecture. This model also supports real-time access to expansive data sets, enabling responsive and dynamic user interactions that cater to increasingly complex user queries with precision and speed. Overall, the API-driven approach represents a substantial advancement in data management technology that significantly optimizes system performance, elevates user experience, and enhances the scalability of the application infrastructure.

FIG. 2B illustrates an example of an API 205 using HTTP basic access authentication that may include a username and password, in accordance with some implementations. The example illustrated in FIG. 2B represents a sample request 210 and a schema 215 (e.g., a JavaScript Object Notation (JSON) schema) including information necessary to access public facing APIs used as a plugin. Structuring data exchange according to a predefined schema reduces the processing resources required for parsing and validation, thereby improving the overall efficiency and speed of the AI-assisted system.

In some implementations, the API 205 may include a set of rules and definitions for enabling communications and interactions between the different systems, methods, and apparatuses described herein (e.g., a specialized software application) and a large-language model or GPT assistant. For example, API 205 may define a set of rules and endpoints for allowing the large-language model or GPT assistant to interact with specialized software, exchange data, and perform actions.

In some implementations, the API 205 may provide an interface for software interactions by defining processes and data formats that software applications may use to request and exchange information thereby allowing differing software systems to interact seamlessly. Using predetermined processes and formats that correspond with software applications can reduce the overall computing power consumed by the system since such that additional power is not needed to reformat the information in order for the systems to communicate.

In some implementations, the API 205 may define specific endpoints that the large-language model or GPT assistant may call on to interact with the different systems, methods, and apparatuses described herein. For example, each endpoint may be configured to control different functionalities such as, among other things, retrieving information, submitting data, and/or executing commands.

In some implementations, the API 205 may use a standard data format such as, for example, a JSON format for data exchange to ensure compatibility between software components.

In some implementations, the API 205 may implement error handling to provide relevant responses in case of failures, such as, among other things, invalid inputs or server errors.

In some implementations, the API 205 may enable authentication and authorization features to ensure that only authorized users may access specified resources or perform specific actions with respect to the different systems, methods, and apparatuses described herein. For example, the API 205 may enable authentication and authorization features via usage of API keys, OAuth tokens, etc.

In some implementations, the schema 215 may be created for the API 205 to define a structure of endpoints of the API 205, associated data, and types of requests and responses being enabled via a large-language model or GPT assistant. The schema 215 may include a structured framework defining a structure, organization, and constraints of data. For example, the schema 215 may be configured to define how data (being used by the large-language model or GPT assistant) is organized, what types of data are allowed, and relationships between different data elements. In some implementations, the schema 215 may be a JSON Schema configured to describe a structure of a JSON object, including allowed properties, associated data types, and any constraints on values. The schema 215 may be configured to define a structure and rules for data storage, validation, and communication.

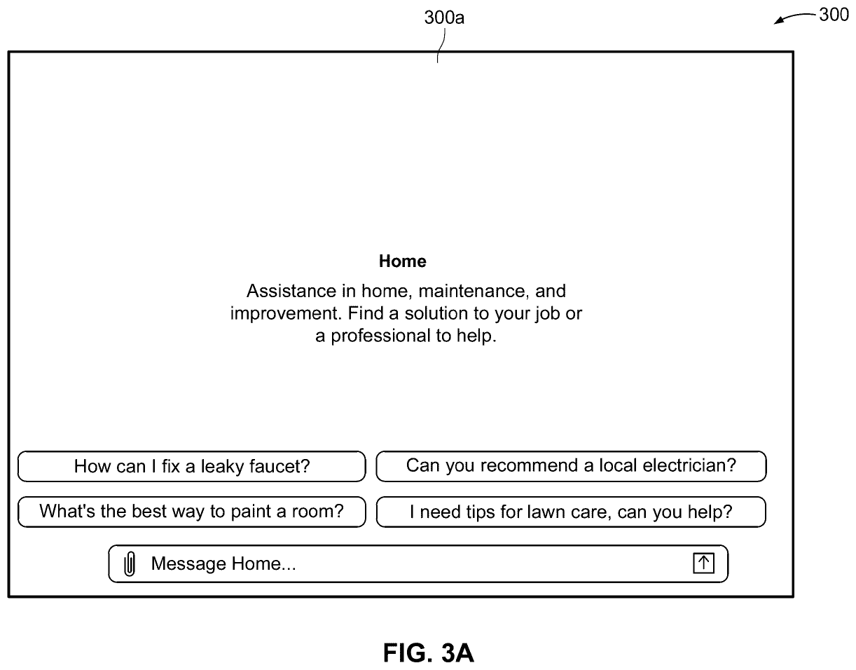

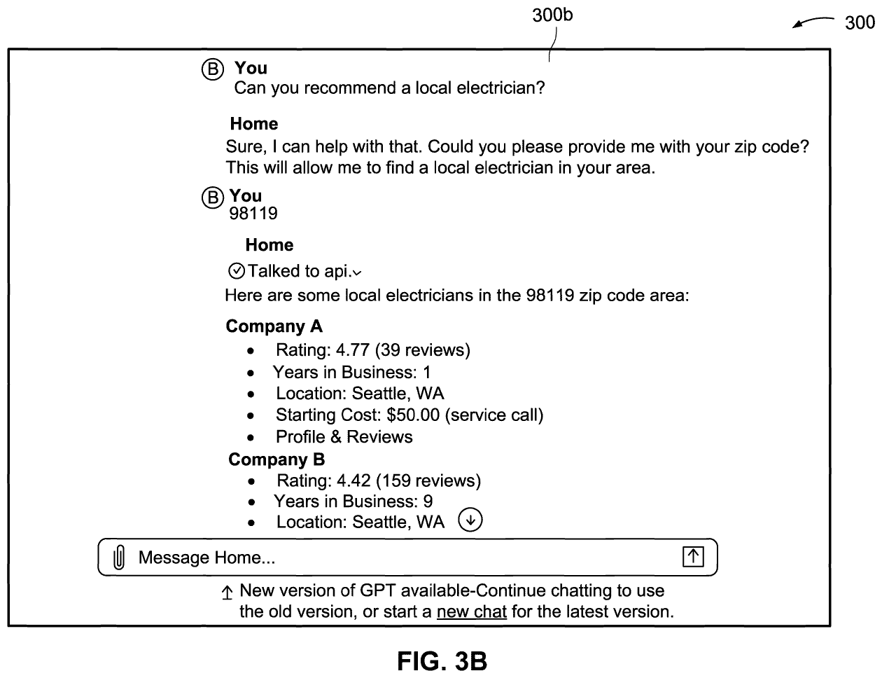

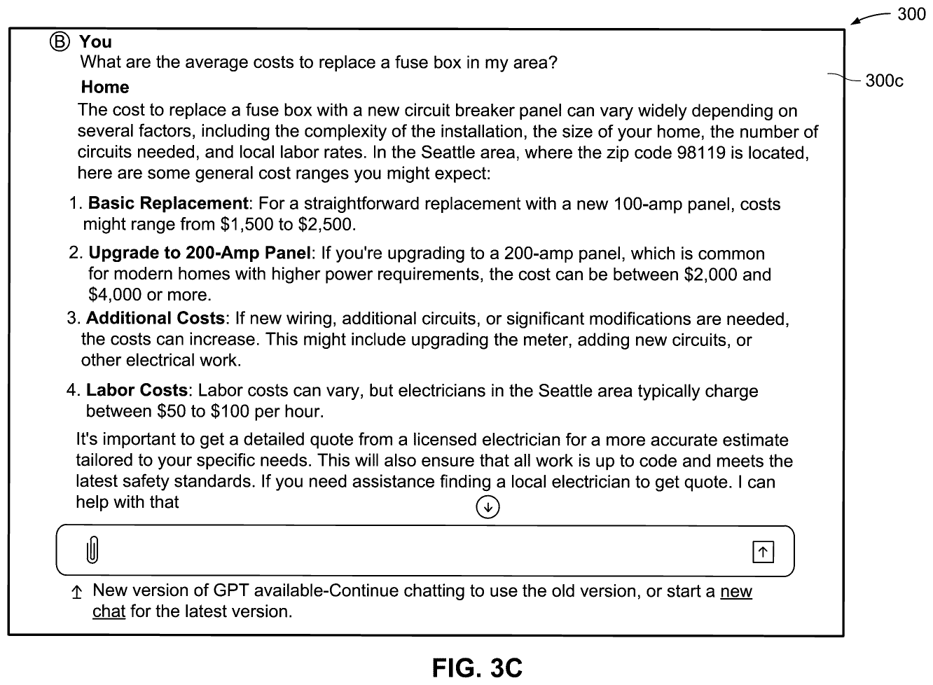

FIGS. 3A-3C illustrate an example of a hardware/software implemented user interface (UI) 300 to offer advice and solutions for home care, repair, and home improvement, in accordance with some implementations. The UI 300 is enabled via a hardware device such as a computer or mobile device.

In the example of FIG. 3A, the UI 300 may present a UI screen 300a enabling a user to ask a question or describe a current home issue (e.g., requiring repair) or a home improvement project to undertake and the systems, methods, and apparatuses described herein may provide relevant advice or guide the user to a professional who may help. For example, a user may request information associated with fixing a leaky faucet, painting a room, caring for a lawn, etc.

The systems, methods, and apparatuses described herein may be connected to a specialized API so that users may easily receive suggestions for local professionals to help complete a home improvement project. The systems, methods, and apparatuses described herein may provide information on associated with a professionals rating, years in business, location, and initial cost as well as profile links and reviews thereby enabling access to a network of, for example, hundreds of thousands of professionals who have earned more than a specified number of 5-star reviews.

In the example of FIG. 3B, the UI 300 may present a UI screen 300b illustrating communications with a user detailing specified companies providing associated services.

In the example of FIG. 3C, the UI 300 may present a UI screen 300c illustrating presentation of advice associated with a specified repair (e.g., an electrical repair).

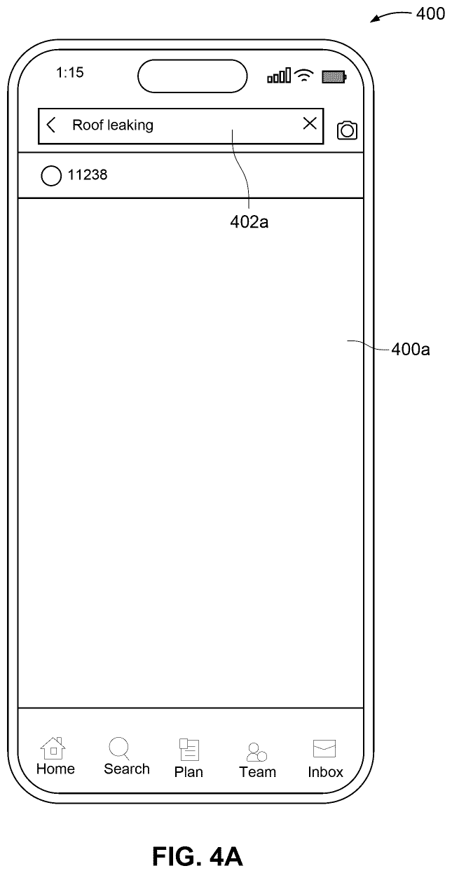

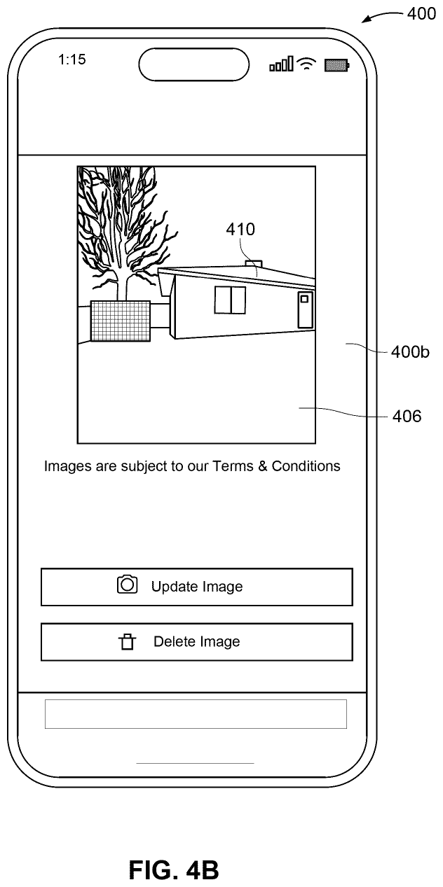

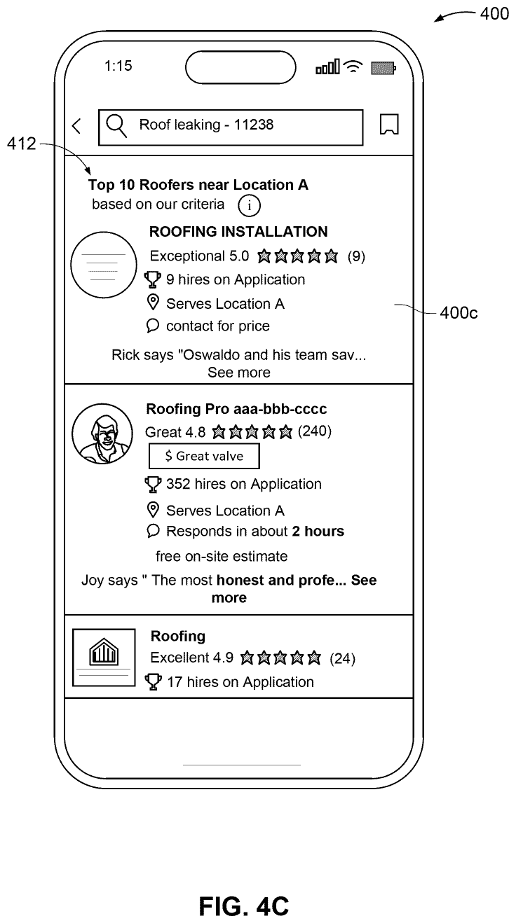

FIGS. 4A-4C illustrate an example of a hardware/software implemented user interface (UI) 400 configured to obtain and analyze video data (e.g., images, a video stream, etc.) and/or audio data to supplement analysis (e.g., as described with respect to FIGS. 3A-3C) for providing specific advice and solutions for home care, repair, and home improvements, in accordance with some implementations. The UI 400 is enabled via a hardware device such as a computer or mobile device.

In the example of FIG. 4A, the UI 400 may present a UI screen 400a enabling a user to describe a current home issue (e.g., requiring repair) or a home improvement project to undertake and the systems, methods, and apparatuses described herein may provide relevant advice or guide the user to a professional who may help. For example, a user may request information (e.g., via a text input field 402a) associated with fixing a leaking roof.

In the example of FIG. 4B, the UI 400 presents a UI screen 400b enabling the user to upload media data 406 (e.g., audio, images, a video stream, etc.) of the repair area (e.g., a roof) to be used in combination with text description data (e.g., entered text input field 402a as illustrated in FIG. 4A) to supplement analysis for providing specific advice and solutions (e.g., recommending a professional(s) to perform repairs) for home care, repair, and home improvements. For example, the media data 406 may illustrate an image or video frame of a roof 410 described as leaking via the text input field 402a in FIG. 4A. The system can locally pre-process video frames to extract only relevant features before transmission to the AI module. Such pre-processing can reduce network bandwidth usage and minimizes the computational load on the AI processor. For example, instead of the AI module receiving a full video and having to parse the whole video to find the relevant portions, the local system (e.g., the application) can perform an initial step of identifying the relevant portions of the video such that the AI module only analyses the relevant portions. As such, each part of the system can specialize in its designated task, which can allow each system to be more efficient at its own task. Further, only having to analyze a portion of a video reduces the computational load on the AI module and decreases processing time.

In response to the uploaded media data 406 from UI screen 400b, the example of FIG. 4C illustrates that the UI 400 may present a UI screen 400c illustrating presentation of advice associated with a specified repair (e.g., a roof repair). For example, UI screen 400c may present a list of contractors 412 (e.g., roofers) that are qualified to perform a roof repair. The UI screen 400c may include ratings, number of times hired, service locations, reviews, highlights, etc. associated with each contractor in the list of contractors 412.

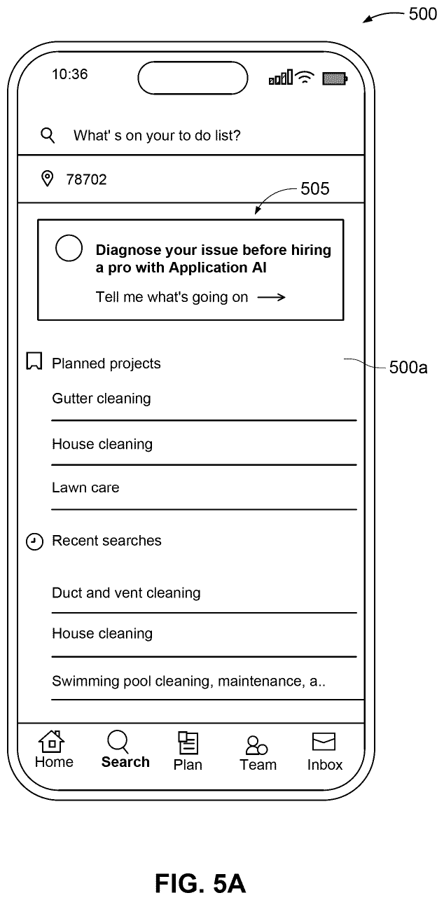

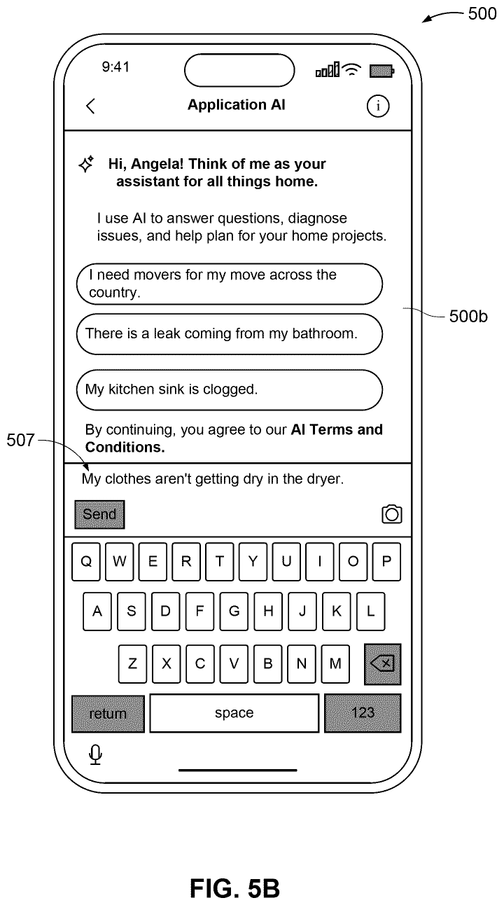

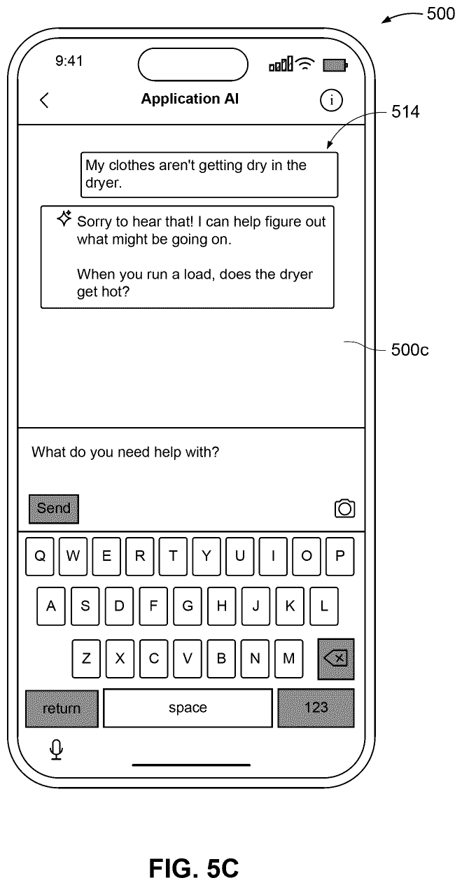

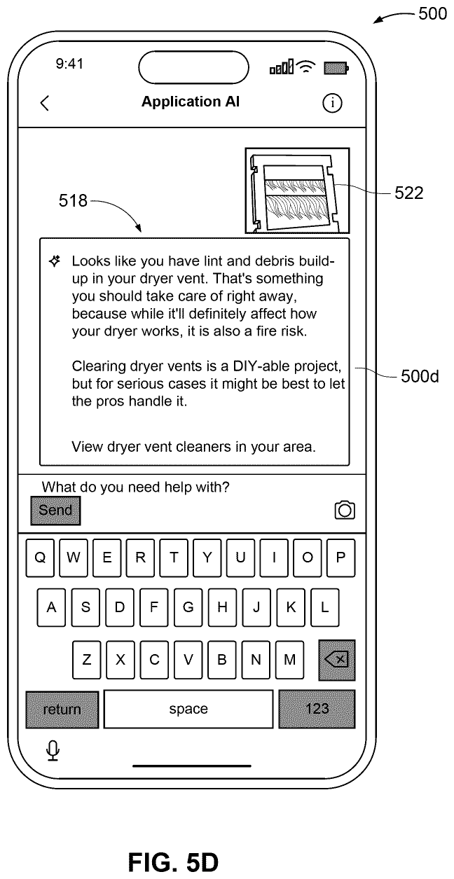

FIGS. 5A-5D illustrate an example of a hardware/software implemented user interface (UI) 500 configured to obtain a description of an issue requiring a resolution (e.g., via a search) and utilize a generative AI interface or module in combination with or independent from a specific prompt knowledge base to provide contextual analysis associated with diagnosing issues requiring attention and provide relevant and personalized advice and solutions for enabling a user to contact a relevant professional to perform a function or repair associated with the issue, in accordance with some implementations. The UI 500 may be enabled via a hardware device such as a computer or mobile device.

In some implementations, the UI 500 may be configured to enable an AI module to use natural language processing (NLP) to interpret written (e.g., text) or spoken (e.g., audible) descriptions of issues requiring attention. Likewise, the AI module may use computer vision (CV) algorithms to analyze uploaded video or images of locations associated with the issues. For example, if a user describes (e.g., via text-based input) a “ceiling stain”, the AI module may use NLP to identify the issue as a potential water leak and may additionally analyze patterns in a related image (e.g., of the ceiling stain) to identify potential causes such as, among other things, roofing issues, plumbing leaks, HVAC condensation, etc. Subsequent to identifying the potential causes of the water leak, the AI module may be configured to suggest a professional (e.g., a plumber, a roofer, a structural engineer, etc.) to repair the water leak and/or provide step-by-step advice (to a user) to correct issues not requiring professional service (e.g., applying caulk or sealer). In some implementations, the AI module may be configured to improve over time by learning from successful resolutions and user feedback thereby refining its diagnoses and recommendations.

In the example of FIG. 5A, the UI 500 may present a UI screen 500a enabling an AI feature entry point 505 that allows a user to communicate with an AI module. For example, the AI feature entry point 505 may include a direct entry point, a contextual entry point based on a surface and category, and/or a contextual entry point based on a search query.

In some implementations, a direct entry point may comprise a direct presentation of an interface of the AI module (e.g., a button, a text description, etc.) within a different presentation experience such as, for example, a home tab of an application. The direct entry point may enable a user to directly engage with the AI module in a manual manner such as pressing a virtual button.

In some implementations, a contextual entry point may be enabled based on a UI surface and category. A UI surface may include interactive elements and/or visual cues that may be configured to guide a user to engage with features of a UI such as, for example, UI 500. For example, a UI surface may include, among other things, a primary button, a floating action button, a search bar or input field, a contextual prompt or suggestive action, a navigation menu, etc. A contextual entry point may be configured to display entry points that are associated with contextual examples with respect to a current user surface. For example, common user questions may be displayed below a search bar and/or common questions for a given category for a category specific surface.

In some implementations, a contextual entry point (e.g., a UI element or prompt) may be enabled based on a search query associated with analyzing an issue being experienced by a user. Subsequently, the query may be sent to the AI module to determine if the user requires assistance with respect to diagnosing the issue or whether the user may skip obtaining assistance and may proceed directly to further steps (e.g., proceeding to a list of professionals). With respect to this exemplary scenario, there may be multiple implementations to determine whether to engage or not with the user. For example, a user may explicitly ask a question, or the AI module may infer whether it believes that the user requires assistance as determined by a type of problem and a holistic analysis of the query.

In the example of FIG. 5B, the UI 500 may present a UI screen 500b enabling initialization of an AI implemented process for providing contextual analysis with respect to a text or audible description 507 and/or a visual description (e.g., an image as described with respect to FIG. 5D, below) associated with diagnosing issues and providing relevant and personalized advice and solutions.

In some implementations, the AI implemented process may be customized based on different AI feature entry points (e.g., as described with respect to FIG. 5A, above) associated with the needs of a user. For example, with respect to users that proactively engage with the AI module based on diagnosis features, an AI experience may be created to with respect to extended user interaction times with less focus on conclusions.

In some implementations in which an AI module determines that a user(s) requires assistance, a direct AI experience may be created based on a prediction that the user may want to converse with the AI and complete a process associated with hiring a professional to correct determined issues. In this case, an AI interaction may be customized with respect to placing less emphasis on user/AI interactions and more emphasis on locating professionals to correct determined issues. Predictively determining whether a user will require professional assistance prior to initiating full AI-based contextual analysis allows the system to bypass certain computationally intensive steps, thereby increasing throughput and reducing latency. For example, if the system determines the user needs assistance, the system can focus its analysis on finding professionals and not waste time and power determining and providing instructions on how the user can fix the problem. Similarly, if the system determines that the user can fix the problem without a professional's assistance, the system can focus on preparing a list of instructions on how to fix the problem and not waste time or power identifying professionals in the area.

In some implementations, subsequent to locating professionals to correct determined issues, an initial list of associated professionals may be presented to the user. For example, the user may customize presentation of the professionals based on a type of characteristic(s) (e.g., professionals currently available, professionals having a specified rating, professionals with good reviews, etc.). In response, a filtered list of professionals may be presented to the user via UI 500.

In some implementations, professionals may be compared and presented to a user based on user preferred dimensions.

In some implementations, a professional may be hired or booked based on results of the user interacting to complete a request form via an AI interface.

In some implementations, users may be enabled to hire a professional based on results of the AI analysis. In this instance, the list of professionals may be displayed with respect to available time/dates for completion of repairs.

In some implementations, a new plan (e.g., to correct an issue by hiring a professional) may be added (e.g., by the user) via the UI 500.

In some implementations, an AI module (e.g., the UI 500) may be configured to generate recommendations (for the user) with respect to correcting issues (e.g., hiring a professional vs do-it-yourself recommendations/instructions).

In some implementations, AI implemented recommendations may be configured to be displayed in combination with types of professionals required. Likewise, instructions for the user to complete repairs themselves may be presented with a description of a degree of difficulty and safety features to complete the repairs.

In the example of FIG. 5C, the UI 500 may present a UI screen 500c enabling differing types of user input interactions 514 associated with interacting with an AI module. For example, user input interactions 514 may include, among other things, text-based interactions, image or photo-based interactions, video-based interactions, audio-based interactions, etc.

In some implementations, the UI screen 500c may enable existing user data to be leveraged with respect to determining issues described via user input. For example, a user's home information (e.g., a location, a type of home, home attributes such as, number of bedrooms, bathrooms, etc.) may be leveraged to customize an AI response. Likewise, a user's past projects (e.g., determined based on previous communications with professionals), service information, user/professional message database, etc. may be leveraged to customize an AI response. Using stored historical interaction data and pre-ranked trusted sources reduces network calls and redundant computations, providing a technical improvement in data retrieval efficiency. For example, the system can access certain sources first that the system determines to have the most relevant information for the current user request. If the first sources do not contain enough information, then additional steps can be performed, but starting with sources that are identified as more relevant can reduce the number of additional steps taken, and reduce the overall time and power consumed.

In some implementations, the UI screen 500c may enable an AI source to determine if an answer (provided via an AI module) for the user may be obtained from various sources such as internal sources and/or external sources. For example, logic for prioritization of sources may be created to provide trustworthy and recommended sources having a higher importance with respect to a response based on availability.

In the example of FIG. 5D, the UI 500 may present a UI screen 500d presenting AI analysis results including a text description 518 and an associated image 522 illustrating issues requiring resolution. For example, UI screen 500d may present AI analysis results that include informing a user that an issue associated with a malfunctioning dryer (e.g., no heat) may be caused by a clogged dryer vent (illustrated via image 522) and that this issue may be resolved by the user or by hiring a professional to clean and/or replace the clogged dryer vent and associated vent tube.

In some implementations, the UI screen 500d may be configured to enable model prompting to craft specified inputs or prompts to guide a machine learning (ML) model towards generating relevant outputs. For example, an AI model may be configured to enable a user to comprehend an issue including providing information such as, among other things, root causes of issues, possible solutions, types of professionals that resolve the issues, do-it-yourself (DYI) resolutions, costs, urgency, additional home project related questions as desired by the user, etc.

In some implementations, an AI model may be configured to prioritize (with respect to providing resolutions to issues) user safety, property safety, third party safety, AI guardrails with respect to laws and regulations, rule of law abidance, regulations and accepted industry protocols, AI guardrails with respect to topics covered, topics allowed by a provider (e.g., home topics), AI guardrails with respect to differing topics with respect to a configured topic, etc.

In some implementations, an AI model may be trained by leveraging a provider's overall message database between customers and professionals to train the AI model with respect to expected questions from multiple parties interacting with each other.

In some implementations, past historical interactions between the users and the AI model may be leveraged to determine successful outcomes based on user interactions and feedback elements.

In some implementations, an evaluator AI model may be leveraged to determine a quality of an interaction with respect to an outcome and safety. For example, an AI evaluator may be configured to create reports with respect to quality based on different dimensions, such as, (a) a quality of an interaction, (b) a safety of a recommendation (c) a quality of a recommendation and subsequent steps, etc.

In some implementations, a safety issue may require a specific interaction pattern, in which the evaluator AI may report a number of interactions deemed a safety risk and segmented by level of risk. Associated interactions may be extracted for manual evaluation. In some implementations, a user and property safety scenario may be generated for automated stress testing.

In some implementations, a conversation may be leveraged to complete a request form beyond AI interfaces. In some implementations, a conversation update may be leveraged with respect to home profile information. In some implementations, AI generated project tips may be displayed subsequent to project creation.

In some implementations, an AI interaction database may be configured to determine popular questions for each category and region, which may be used internally to display within additional user experiences such as new sections of an application, new SEO pages aimed at popular results.

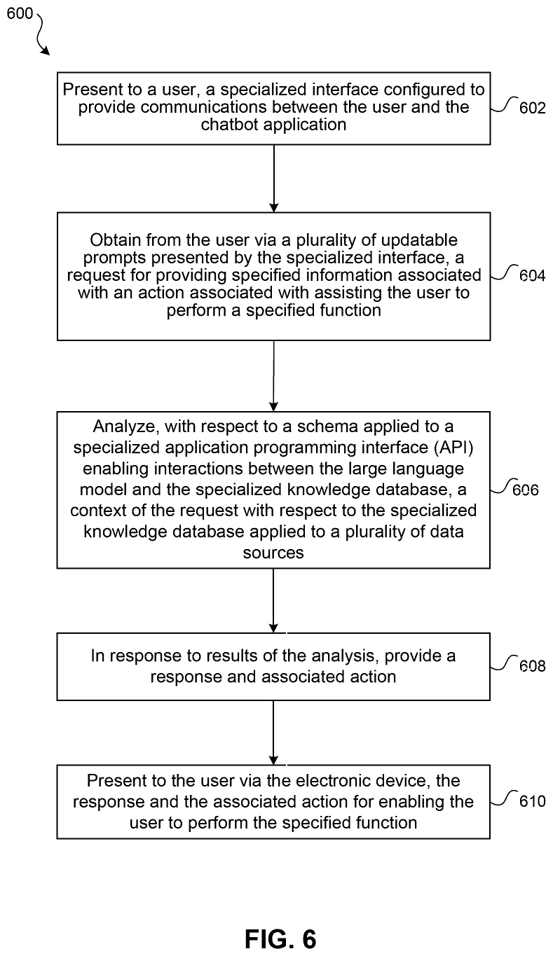

FIG. 6 is a flowchart representation of an exemplary method 600 that enables a hardware/software Web based process for providing relevant information associated with presenting options for enabling a user or qualified entity to perform a specified function, in accordance with some implementations. In some implementations, the method 600 is performed by a device, such as a mobile device, desktop, laptop, server device, or any combination thereof. In some implementations, the method 600 is performed by processing logic, including hardware, firmware, software, or a combination thereof. In some implementations, the method 600 is performed by a processor executing code stored in a non-transitory computer-readable medium (e.g., a memory). Each of the blocks in the method 600 may be enabled and executed in any order.

At block 602, the method 600 presents to a user, a specialized interface configured to provide communications with the user.

At block 604, a request is obtained from the user via a plurality of prompts (e.g., preconfigured questions or statements) presented by the specialized interface. The request is configured to provide specified information associated with an action (advice, details associated with a professional) associated with aiding the user to perform a specified function (e.g., repair a plumbing issue, perform yard maintenance, etc.).

At block 606, the method 600 analyzes, with respect to a schema applied to an API, a context of the request with respect to a specialized knowledge database applied to a plurality of data sources such as, among other things, specialized databases, Internet sources, etc.

At block 608, the method 600, in response to results of the analysis, provides a response and associated action associated with the specified function. The associated action may include, for example, details associated with how to perform a repair, details associated with directly (e.g., via telephone, email, Website, etc.) contacting a professional to perform a repair, etc.

In some implementations, video data may be obtained from the user. The video data may illustrate or present a location (e.g., under a sink) and attributes (plumbing features such as pipes and fittings) associated with performing the specified function. The video data may be analyzed, and results of the analysis may be used to further provide the response and associated action (e.g., advice and solutions) associated with the specified function. The video data may include images, a video stream, etc. In some implementations, the system may extract a subset of frames comprising relevant features from the video data, transmit the subset of frames to the AI module, analyze, via the AI module, the relevant features of the subset of frames, and generate a response based on the analysis of the relevant features of the subset of frames.

In some implementations, audio data may be obtained. The audio data may be user-provided explanations of aspects of a user's request. The audio data may describe a location (e.g., a basement) and attributes (an electrical box and circuit breakers) associated with performing the specified function (e.g., circuit breaker replacement). The audio data may be analyzed and results of the analysis may be used to further provide the response and associated action associated with the specified function. The audio data may be obtained via, for example, a microphone, etc. In some implementations, the system may extract a subset of audio segments describing relevant features from the audio data, transmit the subset of audio segments to the AI module, analyze, via the AI module, the relevant features of the subset of audio segments, and generate a response based on the analysis of the relevant features of the subset of audio segments.

In some implementations, audio and video data may be obtained and analyzed and results of the analysis may be used to further provide the response and associated action (specific advice and solutions for home care, repair, and home improvements) associated with the specified function. For example, the audio and video data may comprise an audio/video stream (provided by the user) comprising a video and associated audio description of walls in a room that may require drywall repair and painting. Accordingly, the method may provide instructions and/or contact information for a professional(s) associated with completing drywall and painting repair work of the room.

In some implementations, the method 600 may be configured to first provide instructions (e.g., a repair manual or guide) associated with enabling the user to complete the specified function as a DIY project. Subsequently, the method may be configured to provide contact information associated with directly contacting a professional entity (e.g., an electrician, a plumber, etc.) to complete the specified action automatically or in response to user request.

In some implementations, the method 600 may be configured to provide contextual analysis associated with determining if the user should attempt to perform the specified function (e.g., a repair) or if the user should contact a professional to perform the specified function. Accordingly, the method 600 may be configured to analyze user input (a skill level or experience of the user), video data (e.g., images, a video stream, etc. of the repair area) and/or audio data (e.g., a user description of the repair and associated area/location) to determine if the user should attempt to perform a function or repair by themselves or if the user should contact a professional to perform a function or repair. For example, analyzed user input (e.g., text, video, and/or audio input) may indicate that the repair requires an electrical breaker box replacement and/or complex electrical wiring and therefore based on a skill level of the user, the method 600 may suggest that the user contact an electrician to complete the repair instead of attempting the repair themselves. In some examples, a look-up-table of known complex or dangerous functions may be compared against the user input, video data, and/or audio data to determine whether the user should contact a profession and/or not recommend the user perform the function themselves.

Determining at an early stage that a described task falls into a predefined “complex or hazardous” category allows the system to skip detailed diagnostic processing stages, saving computing cycles and reducing power consumption. For example, if a task is determined to be complex or hazardous, the system can skip the step of identifying and providing steps to the user to guide the user to fix the problem by themselves. Instead, the system can directly search for professionals to help with the problem. In some implementations, the user can override the complex or hazardous designation by later requesting instructions for performing the task by themselves.

At block 610, the method 600 presents to the user via the electronic device, the response and associated action for enabling the user to accomplish the specified function.

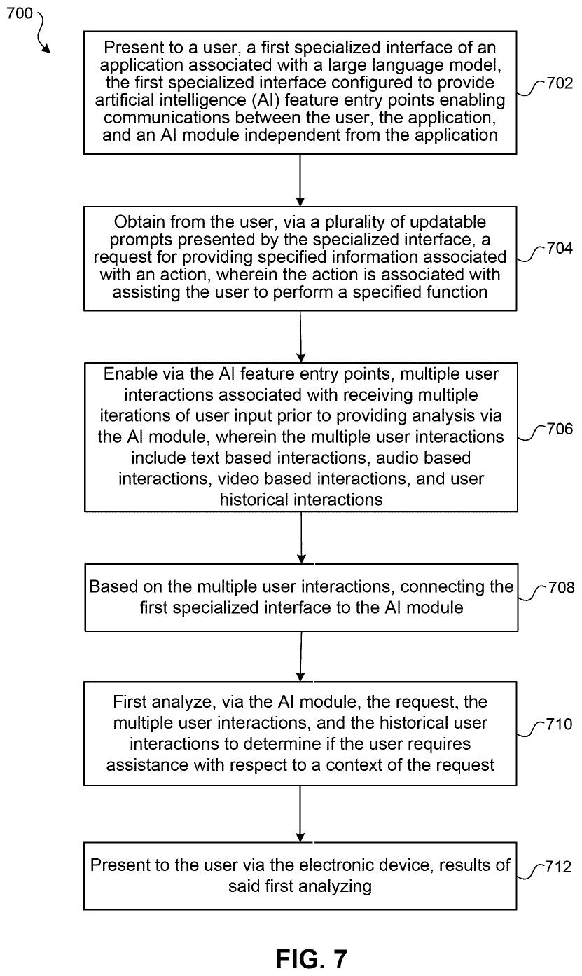

FIG. 7 is a flowchart representation of an exemplary method 700 that enables a hardware/software based process for obtaining a description of an issue requiring a resolution and utilizing an AI interface in combination with or independent from a specific prompt knowledge base to provide contextual analysis associated with diagnosing issues requiring attention and providing relevant and personalized advice and solutions for enabling a user to contact a relevant professional, in accordance with some implementations. In some implementations, the method 700 is performed by a device, such as a mobile device, desktop, laptop, server device, or any combination thereof. In some implementations, the method 700 is performed by processing logic, including hardware, firmware, software, or a combination thereof. In some implementations, the method 700 is performed by a processor executing code stored in a non-transitory computer-readable medium (e.g., a memory). Each of the blocks in the method 700 may be enabled and executed in any order.

At block 702, the method 700 presents to a user, a first specialized interface of an application associated with a large language model configured to provide artificial intelligence (AI) feature entry points enabling communications between the user, the application and an AI module independent from the application.

At block 704, the method 700 obtains from the user, via a plurality of updatable prompts presented by the specialized interface, a request for providing specified information associated with an action, wherein the action is associated with assisting the user to perform a specified function.

At block 706, the method 700 enables via the AI feature entry points, multiple user interactions associated with receiving multiple iterations of user input prior to providing analysis via the AI module. The multiple user interactions may include text-based interactions, audio-based interactions, video-based interactions, and/or user historical interactions. Receiving multiple iterations of user input prior to providing analysis via the AI module reduces the computing power consumed by the AI module. For example, instead of running the AI module every time the user provides a new iteration to analyze each independent interaction, the AI module only analyzes the interactions once the user has provided a threshold amount of information that the application determines is enough to proceed with the AI module analysis. This aggregation step reduces repeated AI execution calls, thereby conserving processor resources and shortening total system processing time.

At block 708, the method 700 connects the first specialized interface to the AI module based on the multiple user interactions.

At block 710, the request, the multiple user interactions, and the historical user interactions are first analyzed, via an artificial intelligence (AI) module, to determine if the user requires assistance with respect to a context of the request.

At block 712, results of the first analysis is presented to the user via the electronic device.

In some implementations, results of the first analyses indicate that the user requires assistance with respect to the context of the request and the method 700 may further include: presenting to the user, via an AI interface of the AI module, personalized attributes associated with enabling communications between the user and the AI module; based on the communications between the user and the AI module, obtaining from the user via the AI interface, an updated request for providing the specified information associated with the action; second analyzing, via the AI module, a context of the updated request; in response to results of said second analyzing, providing a response and associated action associated with the specified function; and presenting, to the user via the electronic device, the response and the associated action for enabling the user or a qualified entity to perform the specified function.

In some implementations, results of the first analyses indicate that the user does not require assistance with respect to the context of the request and the method 700 may further include: second analyzing, with respect to a schema applied to a specialized application programming interface enabling interactions between the large language model and a specialized knowledge database, the context of the request with respect to the specialized knowledge database applied to a plurality of data sources; in response to results of said second analyzing, providing a response and associated action associated with the specified function; and presenting, to the user via the electronic device, the response and the associated action for enabling the user or a qualified entity to perform the specified function.

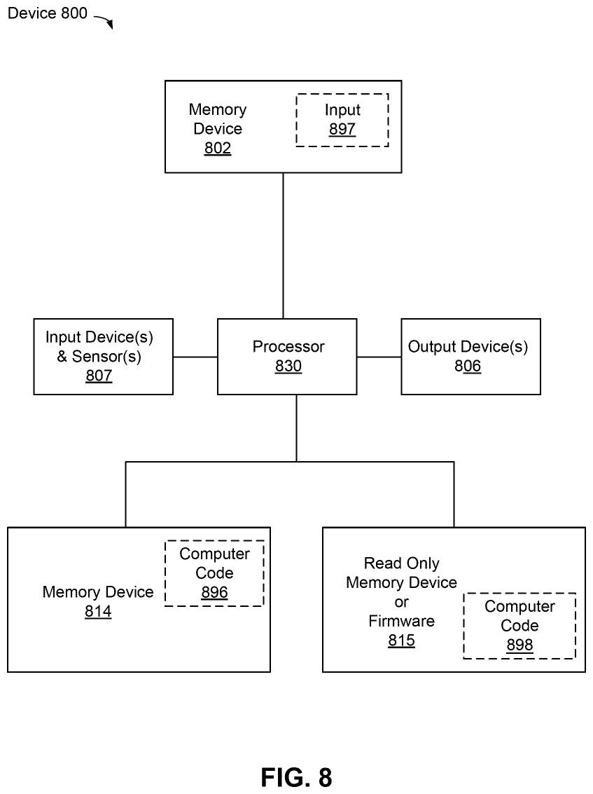

FIG. 8 illustrates a hardware device 800 (e.g., a mobile hardware device, a Web server hardware device, etc.) used by or comprised system for improving software/hardware implemented AI technology associated with receiving a request, from a user, providing specified/relevant information (queried from a specified database and/or the Internet) associated with enabling the user to perform a function and/or recommending an entity to perform the function, in accordance with some implementations.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “engine,” or “system.” The engine, circuit, module, or system may be embodied as one or more circuitry components including, but not limited to, processing circuitry, network interfaces, peripheral devices, input devices, output devices, sensors, etc. In some embodiments, the engine, circuit, module, or system may take the form of one or more analog circuits, electronic circuits (e.g., integrated circuits (IC), discrete circuits, system on a chip (SOCs) circuits, etc.), telecommunication circuits, hybrid circuits, and any other type of circuit. In this regard, the engine, circuit, module, or system may include any type of component for accomplishing or facilitating achievement of the operations described herein. For example, an engine, circuit, module, or system as described herein may include one or more transistors, logic gates (e.g., NAND, AND, NOR, OR, XOR, NOT, XNOR, etc.), resistors, multiplexers, registers, capacitors, inductors, diodes, wiring, and so on). An engine, circuit, module, or system may be embodied as one or more processing circuits comprising one or more processors communicatively coupled to one or more memory or memory devices.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, spark, R language, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, device (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing device to produce a machine, such that the instructions, which execute via the processor of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing device, or other device to cause a series of operational steps to be performed on the computer, other programmable device or other device to produce a computer implemented process, such that the instructions which execute on the computer, other programmable device, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The hardware device 800 illustrated in FIG. 8 includes a processor 830, an input device/sensor 807 coupled to the processor 830, an output device 808 coupled to the processor 830, and memory devices 802 and 814 each coupled to the processor 830. The input device/sensors 807 may be, among other things, a keyboard, a mouse, a camera, a touchscreen, any type of sensors, etc. The output device 806 may be, among other things, a printer, a plotter, a computer screen, a magnetic tape, a removable hard disk, a floppy disk, etc. The memory devices 802 and 814 may be, among other things, a hard disk, a floppy disk, a magnetic tape, an optical storage such as a compact disc (CD) or a digital video disc (DVD), a dynamic random access memory (DRAM), a read-only memory (ROM), etc. The memory device 814 includes a computer code 896. The computer code 896 includes algorithms (e.g., the algorithm of FIG. 4) for improving software/hardware implemented AI technology associated with receiving a request, from a user, providing specified/relevant information (queried from a specified database and/or the Internet) associated with enabling the user to perform a function and/or recommending an entity to perform the function. The processor 830 executes the computer code 896. The memory device 802 includes input data 897. The input data 897 includes input required by the computer code 896. The output device 806 displays output from the computer code 896. Either or both memory devices 802 and 814 (or one or more additional memory devices Such as read only memory device or firmware 815) may include algorithms (e.g., the algorithm of FIGS. 6 and 7) and may be used as a computer usable medium (or a computer readable medium or a program storage device) having a computer readable program code embodied therein and/or having other data stored therein, wherein the computer readable program code includes the computer code 896. Generally, a computer program product (or, alternatively, an article of manufacture) of the hardware device 800 may include the computer usable medium (or the program storage device).

In some embodiments, rather than being stored and accessed from a hard drive, optical disc or other writeable, rewriteable, or removable hardware memory device 814, stored computer program code 896 (e.g., including algorithms) may be stored on a static, nonremovable, read-only storage medium such as a Read-Only Memory (ROM) device 815, or may be accessed by processor 830 directly from such a static, nonremovable, read-only medium 815. Similarly, in some embodiments, stored computer program code 898 may be stored as computer-readable firmware 815, or may be accessed by processor 830 directly from such firmware 815, rather than from a more dynamic or removable hardware data-storage device 814, such as a hard drive or optical disc.

While FIG. 8 shows the hardware device 800 as a particular configuration of hardware and software, any configuration of hardware and software, as would be known to a person of ordinary skill in the art, may be utilized for the purposes stated above in conjunction with the particular hardware device 800 of FIG. 8. For example, the memory devices 802 and 814 may be portions of a single memory device rather than separate memory devices.

The embodiments described herein have been described with reference to drawings. The drawings illustrate certain details of specific embodiments that provide the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112 (f), unless the element is expressly recited using the phrase “means for.”

As utilized herein, terms of degree such as “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to any precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that terms such as “exemplary,” “example,” and similar terms, as used herein to describe various embodiments, are intended to indicate that such embodiments are possible examples, representations, or illustrations of possible embodiments, and such terms are not intended to connote that such embodiments are necessarily extraordinary or superlative examples.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any element on its own or any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the drawings. It should be noted that the orientation of various elements may differ according to other exemplary embodiments, and that such variations are intended to be encompassed by the present disclosure.

Although the drawings may show and the description may describe a specific order and composition of method steps, the order of such steps may differ from what is depicted and described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions, and arrangement of the embodiments without departing from the scope of the present disclosure as expressed in the appended claims.

What is claimed is:

1. A method comprising:
presenting, by one or more processors and to a user via an electronic device, a specialized interface of an application associated with a large language model, the specialized interface configured to provide artificial intelligence (AI) feature entry points enabling communications between the user, the application, and an AI module independent from the application;
obtaining, by the one or more processors and from the user via a plurality of updatable prompts presented by the specialized interface on the electronic device, a request for providing specified information associated with an action, wherein the action is associated with assisting the user to perform a specified function;
connecting, by the one or more processors and based on the plurality of user interactions, the specialized interface to the AI module;
analyzing, by the one or more processors via the AI module, the request, the plurality of user interactions, and historical user interactions to determine if the user requires assistance with respect to a context of the request; and
presenting, by the one or more processors and to the user via the electronic device, a response based on results of the analysis of the request, the plurality of user interactions, and the historical user interactions.

2. The method of claim 1, further comprising:
determining, by the one or more processors and based on the results, that the user requires assistance with respect to the context of the request;
presenting, by the one or more processors and to the user via an AI interface of the AI module, personalized attributes associated with enabling communications between the user and the AI module;
obtaining, by the one or more processors and from the user via the AI interface based on the communications between the user and the AI module, an updated request for providing the specified information associated with the action;
analyzing, by the one or more processors and via the AI module, a context of the updated request;
providing, by the one or more processors and based on analyzing the updated request, a response and associated action associated with the specified function; and
presenting, by the one or more processors and to the user via the electronic device, the response and the associated action for enabling the user or a qualified entity to perform the specified function.

3. The method of claim 1, further comprising:
determining, by the one or more processors and based on the results, that the user does not require assistance with respect to the context of the request;
analyzing, by the one or more processors and with respect to a schema applied to a specialized application programming interface enabling interactions between the large language model and a specialized knowledge database, the context of the request with respect to the specialized knowledge database applied to a plurality of data sources;
providing, by the one or more processors and based on analyzing the results with respect to the schema, a response and associated action associated with the specified function; and
presenting, by the one or more processors and to the user via the electronic device, the response and the associated action for enabling the user or a qualified entity to perform the specified function.

4. The method of claim 1, wherein the multiple user interactions include at least two of text-based interactions, audio-based interactions, or video-based interactions.

5. The method of claim 1, wherein presenting the response includes providing step-by-step instructions enabling the user to perform the specified function.

6. The method of claim 1, wherein presenting the response comprises providing contact information for a plurality of qualified entities to enable the user to directly contact the qualified entity to perform the specified function.

7. The method of claim 1, further comprising:
obtaining, by the one or more processors and from the user via the electronic device, video data illustrating a location and attributes associated with performing the specified function; and
analyzing, by the one or more processors via the AI module, the video data with respect to the context of the request, wherein the response is further based on results of the analysis of the video data.

8. The method of claim 7, wherein analyzing the video data comprises:
extracting, by the one or more processors, a subset of frames comprising relevant features from the video data;
transmitting, by the one or more processors, the subset of frames to the AI module;
analyzing, by the one or more processors via the AI module, the relevant features of the subset of frames; and
generating, by the one or more processors, the response based on the analysis of the relevant features of the subset of frames.

9. The method of claim 1, further comprising:
obtaining, by the one or more processors and from the user via the electronic device, audio data describing a location and attributes associated with performing the specified function; and
analyzing, by the one or more processors via the AI module, the audio data with respect to the context of the request, wherein the response is further based on results of the analysis of the audio data.

10. The method of claim 9, wherein analyzing the audio data comprises:
extracting, by the one or more processors, a subset of audio segments describing relevant features from the audio data;
transmitting, by the one or more processors, the subset of audio segments to the AI module;
analyzing, by the one or more processors via the AI module, the relevant features of the subset of audio segments; and
generating, by the one or more processors, the response based on the analysis of the relevant features of the subset of audio segments.

11. A system comprising:
a non-transitory computer-readable storage medium; and
one or more processors coupled to the non-transitory computer-readable storage medium, wherein the non-transitory computer-readable storage medium comprises program instructions that, when executed by the one or more processors, cause the one or more processors to perform operations comprising:
presenting, to a user via an electronic device, a specialized interface of an application associated with a large language model, the specialized interface configured to provide artificial intelligence (AI) feature entry points enabling communications between the user, the application, and an AI module independent from the application;
obtaining, from the user via a plurality of updatable prompts presented by the specialized interface on the electronic device, a request for providing specified information associated with an action, wherein the action is associated with assisting the user to perform a specified function;
connecting, based on the plurality of user interactions, the specialized interface to the AI module;
analyzing, via the AI module, the request, the plurality of user interactions, and historical user interactions to determine if the user requires assistance with respect to a context of the request; and
presenting, to the user via the electronic device, a response based on results of the analysis of the request, the plurality of user interactions, and the historical user interactions.

12. The system of claim 11, wherein the operations further comprise:
determining, based on the results, that the user requires assistance with respect to the context of the request;
presenting, to the user via an AI interface of the AI module, personalized attributes associated with enabling communications between the user and the AI module;
obtaining, from the user via the AI interface based on the communications between the user and the AI module, an updated request for providing the specified information associated with the action;
analyzing, via the AI module, a context of the updated request;
providing, in response to analyzing the updated request, a response and associated action associated with the specified function; and
presenting, to the user via the electronic device, the response and the associated action for enabling the user or a qualified entity to perform the specified function.

13. The system of claim 11, wherein the operations further comprise:
determining, based on the results, that the user does not require assistance with respect to the context of the request;
analyzing, with respect to a schema applied to a specialized application programming interface enabling interactions between the large language model and a specialized knowledge database, the context of the request with respect to the specialized knowledge database applied to a plurality of data sources;
providing, in response to analyzing the results with respect to the schema, a response and associated action associated with the specified function; and
presenting, to the user via the electronic device, the response and the associated action for enabling the user or a qualified entity to perform the specified function.

14. The system of claim 11, wherein the multiple user interactions include at least two of text-based interactions, audio-based interactions, or video-based interactions.

15. The system of claim 11, wherein presenting the response includes providing step-by-step instructions enabling the user to perform the specified function.

16. The system of claim 11, wherein presenting the response comprises providing contact information for a plurality of qualified entities to enable the user to directly contact the qualified entity to perform the specified function.

17. The system of claim 11, wherein the operations further comprise:
obtaining, by the one or more processors and from the user via the electronic device, video data illustrating a location and attributes associated with performing the specified function; and
analyzing, by the one or more processors via the AI module, the video data with respect to the context of the request, wherein the response is further based on results of the analysis of the video data.

18. The method of claim 17, wherein analyzing the video data comprises:
extracting a subset of frames comprising relevant features from the video data;
transmitting the subset of frames to the AI module;
analyzing, via the AI module, the relevant features of the subset of frames; and
generating, the response based on the analysis of the relevant features of the subset of frames.

19. The method of claim 11, wherein the operations further comprise:
obtaining, from the user via the electronic device, audio data describing a location and attributes associated with performing the specified function; and
analyzing, via the AI module, the audio data with respect to the context of the request, wherein the response is further based on results of the analysis of the audio data.

20. A non-transitory computer storage medium encoded with a computer program, the computer program comprising a plurality of program instructions that when executed by one or more processors cause the one or more processors to perform operations comprising:
presenting, to a user via an electronic device, a specialized interface of an application associated with a large language model, the specialized interface configured to provide artificial intelligence (AI) feature entry points enabling communications between the user, the application, and an AI module independent from the application;
obtaining, from the user via a plurality of updatable prompts presented by the specialized interface on the electronic device, a request for providing specified information associated with an action, wherein the action is associated with assisting the user to perform a specified function;
connecting, based on the plurality of user interactions, the specialized interface to the AI module;
analyzing, via the AI module, the request, the plurality of user interactions, and historical user interactions to determine if the user requires assistance with respect to a context of the request; and
presenting, to the user via the electronic device, a response based on results of the analysis of the request, the plurality of user interactions, and the historical user interactions.
